(19) United States
(12) Patent Application Publication
(10) Pub. No.: US 2012/0312023 A1
(43) Pub. Date: Dec. 13, 2012

(54) THERMAL MANAGEMENT SYSTEMS AND METHODS FOR AUXILIARY POWER UNITS

(75) Inventors: Timothy Ertz, Scottsdale, AZ (US); Gregory Geyer, Phoenix, AZ (US); Thomas Nesdill, Phoenix, AZ (US); Frank Merkley, Phoenix, AZ (US)

(73) Assignee: HONEYWELL INTERNATIONAL INC., Morristown, NJ (US)

(21) Appl. No.: 13/155,966

(22) Filed: Jun. 8, 2011

(51) Int. Cl. B64D 41/00; F02C 7/18; F02C 7/06; F02C 7/057

(52) U.S. Cl. 60/772; 60/39.08

(57) ABSTRACT

An auxiliary power unit (APU) is provided and configured to be mounted in an APU compartment that defines an inlet opening. The APU includes a power section having components lubricated with oil; an intake duct coupled to the inlet opening and the power section and configured to direct a first portion of air flow through the inlet opening into the power section; an oil cooler coupled to the power section and configured to cool the oil of the power unit; a cooling duct coupled to the oil cooler and the intake opening; an inlet door mounted at the inlet opening and configured to open and close the inlet opening, the inlet door further configured to be positioned in at least a first open position and a second open position; and a thermal management system configured to adjust the inlet door between the first open position and the second open position based on one or more operating temperatures within the APU.

### TECHNICAL FIELD

The present invention generally relates to auxiliary power units (APUs), and more particularly relates to thermal management systems and methods for APUs.

### BACKGROUND

Aircraft often have an on-board auxiliary power unit (APU) to provide electrical power and compressed air to various systems. As examples, when the aircraft is on the ground, the APU is the primary source of power to drive the environmental control systems, air driven hydraulic pumps, auxiliary generator, and the starters for the engines. During flight, the APU may provide pneumatic and electric power. Typically, the APU includes a compressor, a combustor, a turbine, and other components that are lubricated with oil cooled by an oil cooler.

The APU is typically arranged in an APU compartment at the tailcone of an aircraft and receives operating and cooling air from the atmosphere through an inlet opening in the exterior surface of the tailcone. An intake duct defines an airflow passage between the inlet opening and the compressor of the APU for generating the pneumatic and electrical power. Additionally, a cooling duct defines an airflow passage between the inlet opening and the oil cooler for cooling the APU oil and/or ventilating the APU compartment. An inlet door selectively opens and closes the inlet opening depending on APU or aircraft requirements.

In most situations, the amount of air flowing through the cooling duct, and thus the oil cooler, is sufficient to cool the APU oil. However, at times, thermal management of the APU may be an issue, particularly during maintenance operations. During a maintenance operation, the APU is typically shut down and maintenance suspended if the temperature of the oil reaches a predetermined elevated temperature. Conventional techniques for increasing the amount of air flow into the cooling duct may include providing fans to draw in additional air. However, these techniques may not be sufficient to properly manage the temperature, may reduce APU performance or efficiency, or may have an adverse impact on the size and weight of the APU.

Accordingly, it is desirable to provide improved thermal management of the APU, particularly during maintenance operations. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, an auxiliary power unit (APU) is provided and configured to be mounted in an APU compartment that defines an inlet opening. The APU includes a power section having components lubricated with oil; an intake duct coupled to the inlet opening and the power section and configured to direct a first portion of air flow through the inlet opening into the power section; an oil cooler coupled to the power section and configured to cool the oil of the power unit; a cooling duct coupled to the oil cooler and the intake opening; an inlet door mounted at the inlet opening and configured to open and close the inlet opening, the inlet door further configured to be positioned in at least a first open position and a second open position; and a thermal management system configured to adjust the inlet door between the first open position and the second open position based on one or more operating temperatures within the APU.

In accordance with another exemplary embodiment, a method is provided for managing an operating temperature of an auxiliary power unit (APU) mounted in an APU compartment and receiving air through an inlet opening selectively opened and closed with an inlet door. The method includes monitoring the operating temperature of the APU; and positioning the inlet door based on the operating temperature.

### BRIEF DESCRIPTION OF THE DRAWINGS

The present invention will hereinafter be described in conjunction with the following drawing figures, wherein like numerals denote like elements, and wherein:

FIG. 1 is a cross-sectional schematic diagram of an aircraft auxiliary power unit (APU) in a first operating condition in accordance with an exemplary embodiment;

FIG. 2 is a cross-sectional schematic diagram of the APU of FIG. 1 in a second operating condition in accordance with an exemplary embodiment;

FIG. 3 is a graph providing inlet door position as a function of temperature for the APU of FIGS. 1 and 2 in accordance with an exemplary embodiment; and

FIG. 4 is a flowchart of a method for managing the temperature of an APU in accordance with an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments described herein provide thermal management systems and methods for maintaining a desired temperature in an auxiliary power unit (APU). Particularly, an intake duct and a cooling duct extend from the inlet opening at the exterior of the aircraft to respectively provide operating air to the power section of the APU and cooling air to the oil cooler of the APU. An inlet door may selectively open and close the inlet opening to adjust air flow characteristics of the intake duct and the cooling duct. During typical operation, the inlet door may be positioned at a first angle. However, during a maintenance operation in which compartment doors of the APU are open, the inlet door may be positioned at a second angle based on the APU temperature. In one exemplary embodiment, the second angle may be less than the first angle to draw air from within the APU compartment through the cooling duct.

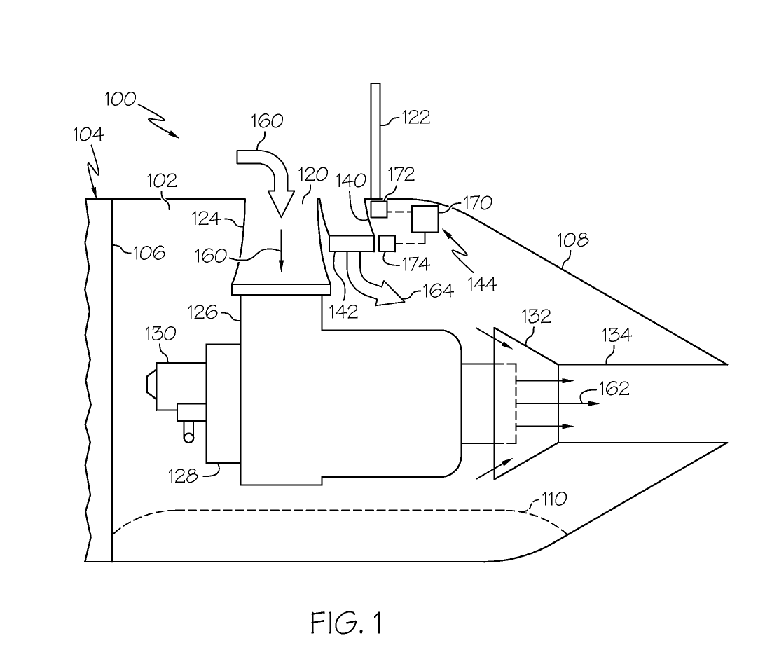

FIG. 1 is a cross-sectional schematic diagram of an engine, which in this embodiment is an auxiliary power unit (APU) 100 installed in an APU compartment 102 in the aft fuselage (or tailcone) of an aircraft 104 in accordance with an exemplary embodiment. The aircraft 104 can be, for example, an airplane. The APU compartment 102 may be formed by the exterior surfaces 108 of the aircraft 104 and separated from the rest of the fuselage by a firewall 106. As described in further detail below, compartment doors 110 are mounted on the underside of the aircraft 104 to allow access to the APU compartment 102 during APU installation or maintenance. In the view of FIG. 1, the compartment doors 110 are closed. As such, during normal operating conditions, the APU compartment 102 is generally enclosed (or sealed) except for the air flow paths described below. In the depicted embodiment, the APU compartment 102 is formed in the tailcone section. It will be appreciated, however, that this is merely exemplary, and that the APU compartment 102 could be formed in any one of numerous other sections of the aircraft 100.

As described in greater detail below, the APU 100 includes an inlet opening 120, an inlet door 122, an intake duct 124, a power section 126, a gearbox 128, a generator 130, an eductor 132, and an exhaust section 134. The APU 100 further includes a cooling duct 140, an oil cooler 142, and a thermal management system 144. As described in greater detail below, the thermal management system 144 is configured to maintain an appropriate temperature of the APU 100 by adjusting the position of the inlet door 122.

Generally, APU 100 functions to provide electrical power and compressed air to various systems of the aircraft 104. The ambient air utilized by the APU 100 during operation is drawn through the inlet opening 120 formed in the exterior surface 108 of the aircraft 104. The intake duct 124 extends from the inlet opening 120 to the power section 126 of the APU 100.

The power section 126 generally includes a compressor, a combustor, and a turbine (not shown). Air flowing through the intake duct 124 (e.g. air flow 160) is compressed in the compressor of the power section 126. A portion of that compressed air may be provided to other components of the aircraft 104, for example, to circulate air through the passenger compartment or to operate pneumatic systems. The remaining portion of the compressed air is mixed with fuel and ignited in the combustor of the power section 126. The resulting hot gases then expand through the turbine to drive the compressor and to drive, via gears in the gearbox 128, the generator 130 for supplying electrical power. The expanded gas (e.g., air flow 162) from the power section 126 is discharged axially through the eductor 132 and the exhaust section 134 out of the aircraft 104.

The APU 100 is lubricated by oil, which in turn, is cooled by the oil cooler 142. The cooling duct 140 extends from the inlet opening 120 to the oil cooler 142 such that a portion of the ambient air flowing through the inlet opening 120 also flows across the oil cooler 142 as cooling air flow 164. As an example, the oil cooler 142 may be an oil-to-air heat exchanger with cooling tubes or fins that enable the cooling air flow 164 to remove heat from the oil in the oil cooler 142.

As noted above, the intake duct 124 and the cooling duct 140 are adjacent to one another and each extends from the inlet opening 120. As such, the inlet opening 120 provides ambient air flow to both of the power section 126 and the oil cooler 142. The inlet opening 120 may be selectively opened and closed by the inlet door 122 pivotally attached to the aircraft 104. Generally, the inlet door 122 is plate-like and is contoured to aerodynamically match the contour of the exterior surface 108 in the closed position to seal the inlet opening 120. In other embodiments, the inlet door 122 may have other configurations to open and close the inlet opening 120.

As shown in FIG. 1, the inlet door 122 is pivoted to open in the direction of ambient air flow during travel to direct a portion of that ambient airflow into the inlet opening 120. The inlet door 122 may adjusted to any desired position, typically expressed as an angle ranging from 0° in which the inlet door 122 is completely closed to 90° in which the inlet door 122 is completely open. In the depiction of FIG. 1, the inlet door 122 is opened to 90°.

As described in greater detail below, the position of the inlet door 122 may be based on the thermal conditions in the APU 100, particularly in the oil cooler 142, and controlled by the thermal management system 144. The thermal management system 144 includes the controller 170, the actuator 172, and the sensor 174 that enable improved thermal management of the APU 100.

The sensor 174 is a temperature sensor, such as a thermocouple, mounted on or within the oil cooler 142 to determine the temperature of the oil in the oil cooler 142. The temperature of the oil in the oil cooler 142 provides an indication of the temperature of the APU 100. In other embodiments, the sensor 174 may be mounted in other locations to provide the operating temperature of the APU 100.

The controller 170 is coupled to the sensor 174 and controls the position of the inlet door 122 by providing position command signals to the actuator 172. Although not specifically shown, the controller 170 may be implemented with one or more computer processors, such as for example, a microprocessor or digital signal processor capable of executing machine instructions or algorithms stored in a database or local memory to perform the functions discussed herein. In one exemplary embodiment, the controller 170 may control the position of the inlet door 122 based on a look-up table that relates position to temperature, as described in greater detail below.

The actuator 172 of the thermal management system 144 is coupled to the inlet door 122 for selectively moving the inlet door 122 into different positions. The actuator 172 may include a motor and a mechanical transmission arrangement such as a rack and pinion arrangement, a threaded screw or spindle with a threaded follower nut, a rod linkage, a push-pull cable linkage (e.g. a Bowden cable), or the like. The inlet door 122 may be opened to any suitable angle, including 0° (e.g., closed) and 90° (as shown in FIG. 1), although as discussed below, the thermal management system 144 functions to provide an improved determination of position based on the temperature characteristics.

As noted above, the eductor 132 is positioned to receive air exhausted from the power section 126. During the operating condition of FIG. 1, the interaction of the power section 126 and the eductor 132 functions to create a low-pressure region in the APU compartment 102 that assists in drawing air through the cooling duct 140 and across the oil cooler 142 as the air flow 164. The cooling air flow 164 may be entrained with the air flow 162 from the power section 126 and exhausted through the exhaust system 134 into the ambient environment.

As such, in the first operating condition shown in FIG. 1, the compartment doors 110 are closed. During a second operating condition, such as when the compartment doors 110 are open, the operation of the eductor 132 and power section 126 may be insufficient to create the low pressure region in the APU compartment 102 that induces the air flow 164 through the cooling duct 140. Unless addressed, the reduction in air flow 164 at the oil cooler 142 may result in increased APU temperatures. However, the thermal management system 144 is configured to address this issue.

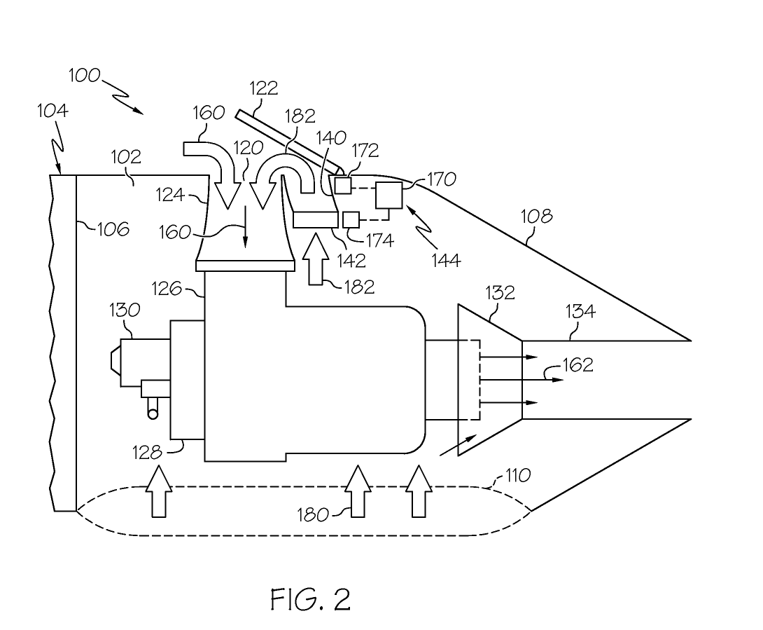

FIG. 2 is a cross-sectional schematic diagram of the APU 100 of FIG. 1 in the second operating condition in accordance with an exemplary embodiment. In contrast to the operating condition of FIG. 1, the compartment doors 110 of the APU compartment 102 are open in FIG. 2. As noted above, this operating condition may result in the absence of the low pressure region created by the eductor 132 during the first operating condition of FIG. 1 because of air flow 180 entering through the open compartment doors 110. As such, the air flow 164 (FIG. 1) from the inlet opening 120 across the oil cooler 142 may be reduced in the condition of FIG. 2. The lack of air flow 164 (FIG. 1) in the condition of FIG. 2 may result in increased APU temperatures, particularly at the oil cooler 142. The open position of the compartment doors 110 in FIG. 2 typically occurs during maintenance in which the APU 100 is operating on the ground but access to the APU compartment 102 is required via the compartment doors 110. If the temperature of the APU 100 reaches a predetermined elevated temperature, such as 250° F., the APU 100 must shut down and the maintenance may be discontinued.

As noted above, the sensor 174 of the thermal management system 144 determines (e.g., monitors or senses) the temperature of the oil at the oil cooler 142. In response to a temperature increase, the controller 170 controls the actuator 172 to adjust the inlet door 122 into a position such as that shown in FIG. 2. Particularly, the controller 170 controls the actuator 172 to adjust the position of the inlet door 122 such that the air gap between the cooling duct 140 and the inlet door 122 at the inlet opening 120 is reduced. During this condition, the power section 126 is still operating to draw air flow 160 from the inlet opening 120 into the intake duct 124. A pressure differential between the relatively low pressure of the intake duct 124 and the relatively high pressure of the cooling duct 140 is a result of the adjusted position of the inlet door 122. In turn, this pressure differential draws air flow 182 from the APU compartment 102, through the cooling duct 140, and into the intake duct 124 to be entrained with the air flow 160 through the intake duct 124 into the power section 124. As the air flow 182 is induced from the APU compartment 102 into the cooling duct 140, the air flow 182 passes across the oil cooler 142, thereby removing heat from the oil and reducing, maintaining, or mitigating the temperature of the APU 100. As illustrated by a comparison of FIGS. 1 and 2, air flow 164 (FIG. 1) though the cooling duct 140 is in a first direction, and air flow 182 (FIG. 2) through the cooling duct 140 is in a second direction, generally opposite to the first direction.

Accordingly, the thermal management system 144 adjusts the position of the inlet door 122 based on the temperature of the APU 100 and particularly decreases the angle of the inlet door 122 in response to temperature increases. The inlet door 122 may be continuously adjusted across a complete range of positions based on temperature, or the inlet door 122 may have discrete positions based on the temperature. For example, the inlet door 122 in the operating condition of FIG. 1 (e.g., when the compartment doors 110 are closed) may have a first position, for example between 45° and 90°, and the inlet door 122 in the operating condition of FIG. 2 (e.g., when the compartment doors 110 are open) may have a single second position, for example, between 0° and 45°, less than about 20°, or about 15°, although any suitable second position may be selected.

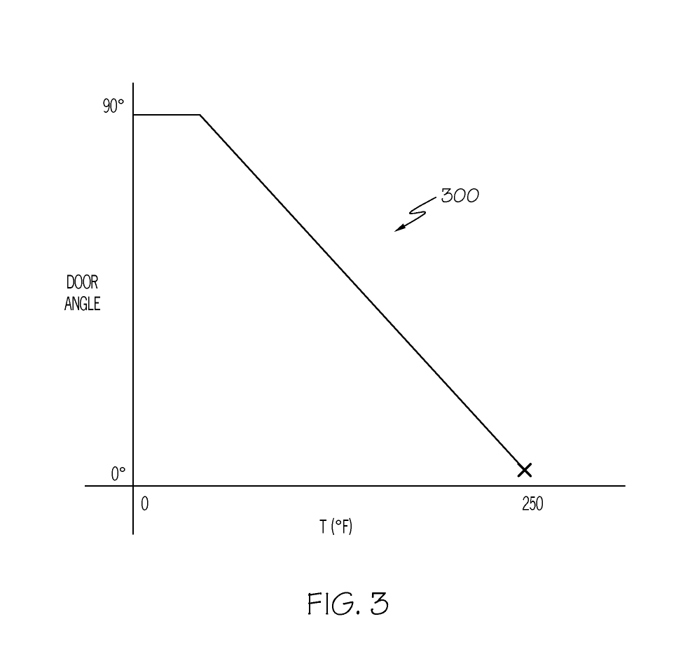

FIG. 3 is a graph 300 that may be used by the controller 170 to control the actuator 172 for adjusting the inlet door 122 based on the temperature data from the sensor 174. Referring briefly to the example of FIG. 3, the graph 300 shows door position (as an angle) expressed as a function of temperature. As shown, the angle of the door position is reduced when the temperature reaches a predetermined temperature and continues to be reduced as the temperature rises. In other embodiments, other temperature and position profiles may be provided. Accordingly, although FIG. 1 shows a first open position of the inlet door 122 and FIG. 2 shows a second open position of the inlet door 122, in one exemplary embodiment, the inlet door 122 may be positioned in any additional open position.

Returning to FIGS. 1 and 2, although the embodiments discussed above include the thermal management system 144 that adjusts the position of the inlet door 122 based on temperature, in other exemplary embodiments, the thermal management system 144 may adjust the position of the inlet door 122 based on other factors that anticipate a temperature increase. For example, the thermal management system 144 may automatically adjust the position of the inlet door 122 when the compartment doors 110 are opened to prevent or mitigate an anticipated increase in temperature. In such an embodiment, the sensor 174 that determines temperature may be omitted and/or replaced with a sensor that evaluates the position of the compartment doors 110. Additionally, in some embodiments, the open position of the compartment doors 110 may be a pre-condition of initializing the thermal management system 144. In other embodiments, the thermal management system 144 may be operated independently of the compartment doors 110.

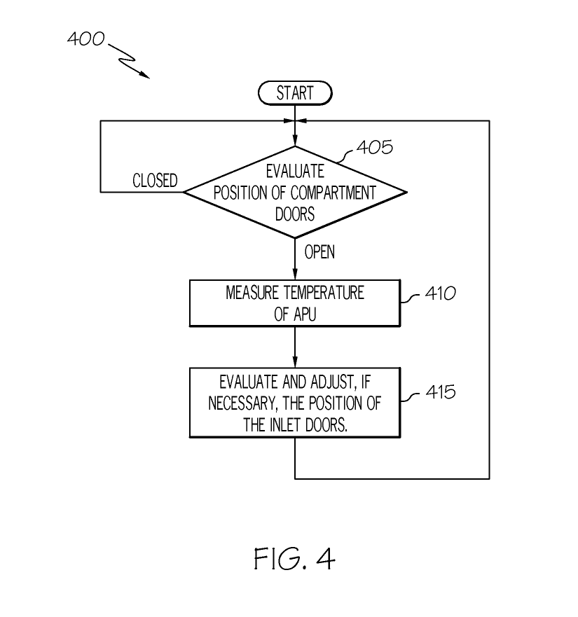

FIG. 4 is a flowchart of a method 400 for managing the temperature of an APU in accordance with an exemplary embodiment. The method 400 may be implemented with the thermal management system 144 in the APU 100 of FIGS. 1 and 2. As such, FIGS. 1 and 2 are referenced below with the discussion of FIG. 4.

In a first step 405 of the method 400, the position of the compartment doors 110 may be evaluated. The compartment doors 110 may be evaluated by visual inspection of an operator or automatically detected by a sensor (not shown). If the compartment doors 110 are closed, the method 400 returns to step 405 and continues monitoring the compartment doors 110. If the compartment doors 110 are open in step 405, the method 400 proceeds to step 410 in which the temperature of the APU 100 is determined. In one exemplary embodiment, the temperature may be provided by the sensor 174 at the oil cooler 142.

In step 415 of the method 400, the position of the inlet door 122 is evaluated and adjusted, if necessary, based on the temperature. Particularly, the position of the inlet door 122 may be decreased to reduce the air gap between the cooling duct 140 and the inlet door 122 at the inlet opening 120. The reduced position of the inlet door 122 functions to draw air from the APU compartment 102, across the oil cooler 142, through the cooling duct 140, and into the intake duct 124, thereby reducing or maintaining the temperature of the APU 100. As described above, the inlet door 122 may be adjusted to a predetermined position at a predetermined temperature (or temperature increase), or the inlet door 122 may be continuously adjusted as the temperature changes. After step 415, the method 400 returns to step 405.

Accordingly, exemplary embodiments discussed herein provided improved thermal management of the APU without substantial adverse impacts to APU performance, efficiency, or cost. In particular, the thermal management systems and methods reduce, maintain, or mitigate temperature issues of the APU, particularly during maintenance, thereby increasing the possible duration of maintenance and improving the useful life of the APU.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An auxiliary power unit (APU) mounted in an APU compartment that defines an inlet opening, the APU comprising:
a power section having components lubricated with oil;
an intake duct coupled to the inlet opening and the power section and configured to direct a first portion of air flow through the inlet opening into the power section;
an oil cooler coupled to the power section and configured to cool the oil of the power unit;
a cooling duct coupled to the oil cooler and the intake opening;
an inlet door mounted at the inlet opening and configured to open and close the inlet opening, the inlet door further configured to be positioned in at least a first open position and a second open position; and
a thermal management system configured to adjust the inlet door between the first open position and the second open position based on one or more operating temperatures within the APU.

2. The APU of claim 1, wherein the inlet door, in the first open position, is open at a first angle, and the inlet door, in the second open position, is open at a second angle, and wherein the first angle is greater than the second angle, and
wherein the thermal management system is configured to position the inlet door at the first open position at a first operating temperature and at the second open position at a second operating temperature, the first operating temperature being less than the second operating temperature.

3. The APU of claim 1, wherein the thermal management system comprises
a sensor configured to determine the operating temperatures;
an actuator configured to adjust the inlet door between the first open position and the second open position; and
a controller coupled to the sensor and the actuator, the controller configured to provide command signals for the actuator based on the operating temperatures determined by the sensor.

4. The APU of claim 1, wherein the first open position of the inlet door corresponds to a first operating condition and the second open position of the inlet door corresponds to a second operating condition, and
wherein, in the first operating condition, the cooling duct is configured to direct a second portion of air flow through the inlet opening and across the oil cooler in a first direction, and
wherein, in the second operating condition, the cooling duct is configured to direct a third portion of air flow across the oil cooler and through the inlet opening in a second direction.

5. The APU of claim 4, wherein the aircraft includes compartment doors to provide access to the APU compartment, the compartment doors being closed in the first operating condition and open in the second operating condition, and
wherein the APU further comprises an eductor positioned to receive combustion gases from the power section and to draw air through the cooling duct during the first operating condition, and
wherein the power unit is configured to draw air through the cooling duct via the intake duct during the second operating condition.

6. The APU of claim 1, wherein the thermal management system configured to adjust the inlet door into the second open position during a maintenance operation.

7. The APU of claim 1, wherein the inlet door is further configured to be positioned in additional open positions, the thermal management system configured to continuously adjust the inlet door between the first open position, the second open position, and the additional open positions based on the operating temperatures.

8. The APU of claim 1, wherein the first open position is at an angle approximately between 45° and 90° and the second open position is at an angle approximately between 0° and 45°.

9. The APU of claim 1, wherein the second open position is at an angle approximately less than 20°.

10. A method of managing an operating temperature of an auxiliary power unit (APU) mounted in an APU compartment and receiving air through an inlet opening selectively opened and closed with an inlet door, the method comprising the steps of:
monitoring the operating temperature of the APU; and
positioning the inlet door based on the operating temperature.

11. The method of claim 10, wherein the positioning step includes reducing an opening angle of the inlet door as the operating temperature increases.

12. The method of claim 10, wherein the positioning step includes
positioning the inlet door at a first angle at a first temperature, and positioning the inlet door at a second angle at a second temperature, the second temperature being greater than the first temperature and the first angle being greater than the second angle.

13. The method of claim 12, wherein the position step further includes
positioning the inlet door at the first angle of approximately between 45° to 90° at the first temperature, and
positioning the inlet door at the second angle of approximately between 0° to 45° at the second temperature.

14. The method of claim 10, wherein the APU includes a power section coupled to an intake duct and an oil cooler coupled to a cooling duct, and wherein the method further comprises the steps of
directing a first air flow, in a first operating condition, from the inlet opening, through the cooling duct, and across the oil cooler; and
directing a second air flow, in a second operating condition, from the APU compartment, across the oil cooler, through the cooling duct, and into the intake duct.

15. The method of claim 10, wherein the APU includes a power section coupled to an intake duct, an oil cooler coupled to a cooling duct, and an eductor coupled downstream to the power section, and wherein the method further comprises the steps of
drawing a first air flow, in a first operating condition, through the cooling duct with the eductor; and
drawing a second air flow, in a second operating condition, through the cooling duct with the power unit.

16. The method of claim 10, wherein the APU compartment includes compartment doors, and wherein the method further comprises the step of positioning the inlet door based on the position of the compartment doors.

17. The method of claim 10, wherein the inlet door is configured to be positioned at an angle and the APU compartment includes compartment doors, and wherein the method further comprises the step of decreasing the angle of the inlet door when the compartment doors are open.

18. The method of claim 17, wherein the decreasing step includes decreasing the angle to less than approximately 20°.

19. The method of claim 17, wherein the decreasing step includes decreasing the angle to approximately 15°.

20. A method of managing an operating temperature of an auxiliary power unit (APU) mounted in an APU compartment accessible with APU compartment doors, the APU receiving air through an inlet opening selectively opened and closed with an inlet door, the method comprising the steps of:
determining if the APU compartment doors are open or closed;
positioning the inlet door in a first position when the APU compartment doors are closed; and
positioning the inlet door in a second position when the APU compartment doors are open.
